(19) United States
(12) Patent Application Publication
(10) Pub. No.: US 2016/0253020 A1
(43) Pub. Date: Sep. 1, 2016

(54) ELECTRONIC DEVICE WITH FORCE DETECTION

(71) Applicant: 3M INNOVATIVE PROPERTIES COMPANY, Saint Paul, MN (US)

(72) Inventor: Matthew H. Frey, Cottage Grove, MN (US)

(21) Appl. No.: 15/023,421

(22) PCT Filed: Nov. 19, 2014
(86) PCT No.: PCT/US14/66327

§ 371 Date: Mar. 21, 2016

Related U.S. Application Data
(60) Provisional application No. 61/907,126, filed on Nov. 21, 2013.

(51) Int. Cl. G06F 3/041; G06F 1/16

(52) U.S. Cl. CPC G06F 3/0414; G06F 1/1694

(57) ABSTRACT

A touch sensor is disclosed. The touch sensor includes a resonant circuit that has a resonant frequency configured to change in response to a force applied to the touch sensor. The touch sensor detects the applied force by detecting a change in the resonant frequency.

### BACKGROUND

There is a need in the art to detect and measure the stress applied by a user to an electronic device. In general, the stress applied to the electronic device may be distributed variously along the outside surface of the device. The stress applied to an electronic device can be, at each point along the surface of the device, comprised of normal compressive, normal tensile, and shear components (shear having itself two directions in a plane tangential to the surface at a given point). The stress can include the magnitudes (normal and shear) and positions of one or more generally localized forces applied to the display of an electronic device (e.g., as would derive from one or more users touching the display surface and in doing so applying some magnitude of force at the locations of touch). Localized force refers to force applied to the outside surface of an electronic devices that is not distributed across the entire surface of the device (as would be the case, for example, when an electronic device would be subjected to isostatic compression). A localized force may be applied over an area approximately equal to the area of contact between a human finger and the outside surface of an electronic device, or alternatively for example the area of contact between a stylus and the outside surface of an electronic device. The outside surface of an electronic device includes the viewable display surface (or stated differently, the display) of the device. As used herein, a force applied to the display of an electronic device can include a force applied to a separate (e.g., protective) layer (e.g., glass or plastic) that overlays a display module within the electronic devices. The detected and measured stress can also derive from forces applied to portions of the device where a display is not located or viewable. For a typical device having a single display (e.g., a tablet, cellular telephone, smartphone, electronic reader, digital media player), examples of portions of the device where a display is not located or viewable include the backside of the device and peripheral edges of the device. In most use scenarios, a force applied to the display of an electronic device is at least partially balanced by an opposite force or forces applied elsewhere on the surface of the device (i.e., portion or portions of the device where the display is not located). In some use scenarios, opposite (or balanced) forces can be applied to an electronic device wherein none of the forces is applied to the display (e.g., as would occur when a typical electronic device having generally flat form factor and a display on one major surface is squeezed at its edges). The designs and methods disclosed herein relate to the detection, location, and measurement of any and all of the aforementioned stresses.

### SUMMARY OF THE INVENTION

The present disclosure is concerned with electronic device designs and methods for detecting, locating, and measuring one or more stresses applied to the electronic device (e.g., localized stresses, for example the stresses associated with one or more human or stylus touches to a display). The designs include electrically coupled resonant members or electromechanical transducers. The methods comprise approaches for detecting, locating, and measuring one or more stresses applied to an electronic device by i) using the mechanical response of resonant members to the one or more stresses applied to the electronic device; or ii) detecting a change in the propagation of vibration modes in or on the electronic devices that are caused by the one or more stresses applied to the electronic devices; or iii) both. In some embodiments, methods include separating acceleration forces applied to an electronic device from distortion forces applied to the electronic device, by operating on measurement of motion made by one or more accelerometers and operating on measurements of stress applied to the electronic device by one or more of the means described herein for detection, location, and measurement of such applied stress.

### DESCRIPTION OF FIGURES

FIG. 1 illustrates an electronic device.

FIGS. 2A and 2B illustrate an electronic device with two resonant piezoelectric crystals supported by elastomeric materials designed to vary in contact area and force on the crystals according to force applied to the electronic device display cover layer.

FIG. 3 illustrates an electronic device having a vibration signal transmitter and a vibration signal receiver, both embedded within the electronic device.

FIG. 4 illustrates a method for isolating distortional forces from acceleration forces for an electronic device.

### DETAILED DESCRIPTION

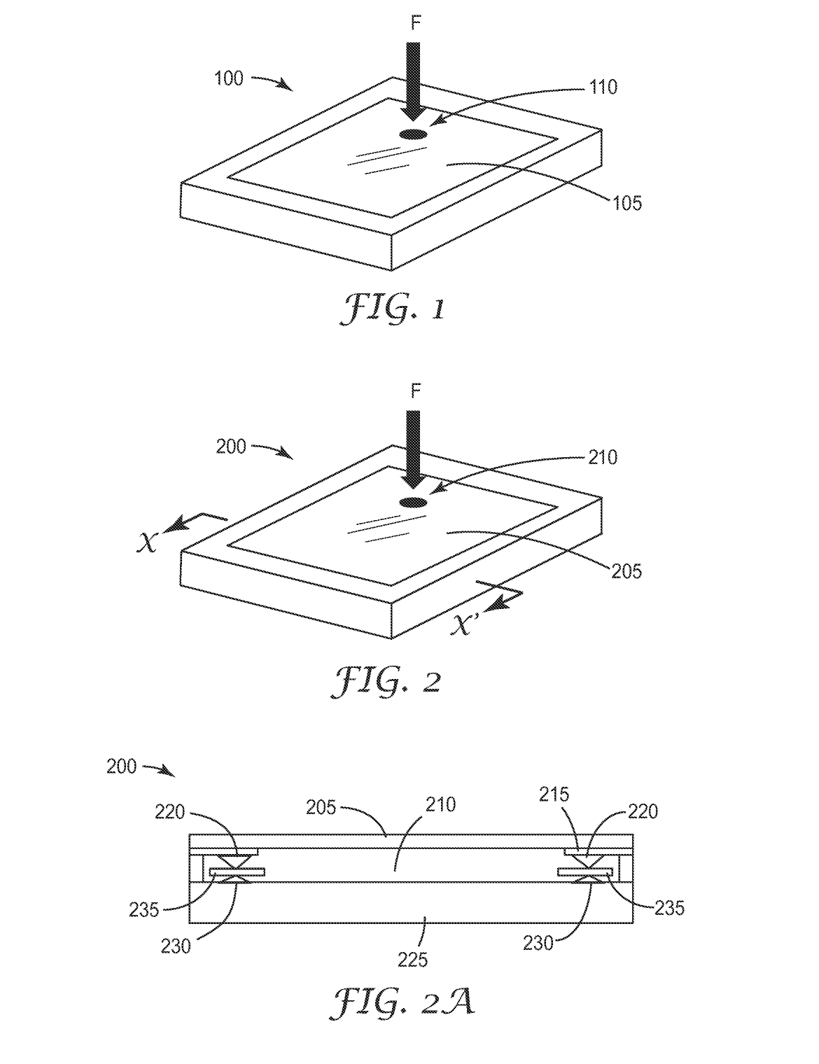

The present disclosure is concerned with electronic device designs and methods for detecting, locating, and measuring one or more stresses applied to the electronic device (e.g., localized stresses, for example the stresses associated with one or more human or stylus touches to a display). FIG. 1 illustrates an electronic device 100 with display 105 and a normal compressive force applied to the display at location 110. Stress is generally expressed in units of force per unit area—accordingly force and stress are directly related. Where not necessary to draw a precise distinction according the aforementioned definitional relationship between force and stress, the words “force” and “stress” may be used interchangeably herein.

Electronic Devices that Detect Applied Stress by Electrically Coupled Resonant Members

As used herein, electrically coupled resonant members include mechanically resonant members and resonant electrical members (which may or may not have electromechanical elements, for example piezoelectric elements (e.g., piezoelectric filters)).

Mechanical resonance phenomena (that occur for mechanically resonant members herein) arise in systems having a combination of perturbing and restoring forces. Inertial factors and restoring force factors combine to generate a natural frequency of resonance. Such mechanical resonances can be electrically detected by any of a variety of means that are well known in the art. For example, a piezoelectric material, depending on its shape, density, modulus, and mechanical support can oscillate a natural frequency that is directly detectable electrically, if the piezoelectric material is appropriately electroded. Such phenomena form the basis quartz crystal movements in watches, as well as quartz crystal microbalances that are used as the basis of chemical sensors or thickness monitors in vacuum thin film deposition systems. Piezoelectric systems include, for example, lead zirconium titanate (PZT) ceramics, lead magnesium niobate—lead titanate crystals, quartz crystals, zinc oxide, poly(vinylidene fluoride). Other electromechanical materials may also be useful for the designs and methods described herein (electrostrictive, flexoelectric). This disclosure is not intended to be limited by the specific modes of mechanical resonance detection that are described herein. Others are known in the art and are useful for the present disclosure.

Electrical resonance phenomena (as occur for electrically resonant members herein) arise in electrical circuits (i.e., resonant circuit) having capacitive or inductive elements, as is well known in alternating current circuit design. Resistors (R) can be combined with capacitors (C) or inductors (L) (or both) to generate resonant RC, RL, or RLC circuits. Capacitors can be combined with inductors to generate resonant LC circuits. The resonance frequency of such resonant circuits depends on the impedance values (i.e., resistance, capacitance, inductance) of respective circuit elements, and their arrangement, as is well known in the art. The resonance frequency (also referred to herein as resonant frequency) can be shifted by changing any of the impedance values of the respective circuits. In some embodiments described herein, stress applied to electronic devices results in a change in impedance values for one or more circuit elements within one or more resonant circuits. A change in resistance can result from straining a resistor (e.g., increasing the resistance by stretching the resistor in the direction of electrical current flow). A change in capacitance can result from straining the capacitor (e.g., increasing the capacitance by compressing parallel plates of a parallel plate capacitor toward each other). This disclosure is not intended to be limited by the specific modes of electrical circuit resonance shift (i.e., as a result of applied stress) that are described herein. Others are known in the art and are useful for the present disclosure.

One or more of the aforementioned electrically coupled resonant members may be integrated within an electronic device in any such manner that stresses applied to the electronic devices results in shifts in their resonance frequencies. Electronic circuitry (e.g., oscillator circuits, filters, comparators, amplifiers, and microprocessors) can be combined with the members in order to determine their changes in resonance frequencies, as is known in the art. Determination of the stress or stresses applied to the surface of the electronic devices can be based on changes in the resonance frequencies by logic operations carried out on the frequency changes, as well as reference to programmed or machine learned changes. Changes in resonance frequencies for the one or more (e.g., 2, 3, 4, 5, 6, 7, 8, 9, 10) members are thus associated with the existence, location, and magnitude of one or more stresses (normal and shear) applied to the surface of the electronic device.

The member or members can be integrated with any one or more of the electronic device display, display cover layer, device housing, device buttons, device substructure (e.g., frame or strut elements not visible to the user). The member or members can be integrated with a device speaker. The member or members may comprise a transparent conductive material, for example a patterned transparent conductive material, for example a microscopic metal mesh, as described in U.S. Pat. Nos. 8,384,691 and 8,274,494 and PCT Patent Application Publication Nos. WO2012106417 and WO2011156447). Alternatively, the transparent conductive material may be a transparent conducting oxide such as indium tin oxide (ITO). The transparent conductive material may be patterned into a transparent conductive element, for example a resistor or at least a portion of a capacitor. The member or members may be advantageously placed at the periphery of a display or display cover layer.

In one exemplary embodiment a transparent conductive element is integrated with a display cover layer as resistive element (e.g., a resistive bar). The resistive element is connected in an electrical circuit with a separate capacitor in order to form an RC circuit with a starting resonance frequency. When the cover layer of the display is touched with a given force, the cover layer will deflect, thereby straining the resistor and changing its resistance. The change in resistance will cause a change in resonance frequency for the aforementioned RC circuit. As described above, the change in resonance can be determined by additional electronic circuitry (as is known in the art) and thus indicate the level or magnitude of force applied to the display.

In another exemplary embodiment, a transparent conductive element is integrated with a display cover layer as a capacitor plate attached to a capacitive measurement circuit. The circuit rely upon the self-capacitance of the plate (also referred to herein as its capacitance to ground) in a resonant circuit or it may use the capacitance of a capacitor formed by the plate (also referred to herein as the first plate) with another electrode (e.g., another plate that is integrated with the display, for example a liquid crystal display module) in a resonant circuit. When the cover layer of the display is touched with a given force, the cover layer will deflect, thereby changing the position of the first capacitor plate, relative to the second electrode or other elements of the first plate's environment. The change in position of the first plate will change the capacitance, thus causing a change in resonance frequency for the aforementioned resonant circuit. As described above, the change in resonance can be determined by additional electronic circuitry (as is known in the art) and thus indicate the level or magnitude of force applied to the display.

The member or members may be supported by elastomeric materials components that are designed to vary in their contact area or contact force (or both) as a result of stress applied to the electronic devices. FIGS. 2 and 2A illustrate an electronic device 200. FIG. 2A is a cross-sectional rendering of the device according to the section XX′. The electronic device 200 includes display cover layer 205 and a normal compressive force F applied at location 210. The device 200 also includes piezoelectric resonators 235 in contact with elastomeric materials 220 and further supports 230 (optionally elastomeric). The cover layer includes graphic border 215 to obscure the view of the resonators 235 and their supports. When force F is applied to cover layer 205, elastomeric materials 220 are pressed against resonators 235, changing their resonance frequency. The resonators are connected (not shown) to electronic circuitry designed to measure their change in natural frequency. The change in natural frequency is correlated with the magnitude of applied force F. Region 210 may be filled with air or may be filled with a solid material, for example an optically clear adhesive.

The member or members may be mechanically coupled to damping materials.

The member or members may be integrated within or on the device in a portion of the device that is not the display region. The member or members may be coupled with a portion of the device that is intentionally designed to detect a balancing force to one or more forces applied to the display, and thusly detect, locate, or measure (or two or more of these) touches made to the display (e.g., by the finger or fingers of one or more users or by a stylus).

Preferably, the member or members are placed in such a way that the accuracy and reliability of stress detection, location, and measurement are not impaired by the addition of a cover (e.g., backside cover) to the electronic device.

In some embodiments, changes in resonance for two or more members are used in coordination (e.g., using a microprocessor and programmed or machine learned parameters) to detect, locate or measure (or two or more of these) stresses (e.g., localized stresses) applied to the surface of an electronic device (e.g., applied to the display of an electronic device).

In some embodiments, the determination of location or locations of one or more touches on the surface of an electronic device, for example on the display of the electronic device, is made using a first sensor or sensor element (e.g., a resistive or capacitive (for example projected capacitive) touch sensor) and the determination of the levels (also described herein as magnitudes) of force for the one or more touches is made using the one or more resonant members as described herein. For more than one touch, the determination of the levels of force for the multiple touches (for example, to a display) can include determining the each level of touch force for each touch or a total force for all of the touches.

In some embodiments, the resonant member may be included as part of a sensor that determines touch location or locations by a means not directly related to the changes in resonant frequency as described herein. For example, a resistive or capacitive circuit element in a resonant electrical circuit described herein may serve the dual purpose (for example at a different point in time, as described by a duty cycle) of sensing touch position by capacitive or resistive detection means that does not necessarily relate to the aforementioned circuit resonance. For example, a transparent conductive element on or in a display or display cover layer (for example as a resistor or one plate in a capacitor) may at one point in time (or portion or fraction of time) during a sensing cycle be included in a resonant circuit and the resonance frequency of the circuit be measured and correlated with the magnitude of force or stress applied to the display (e.g., by one or more touches to the display), and at another point in time (or portion or fraction of time) during a sensing cycle be included in a mutual capacitance, self-capacitance, trans-capacitance, or resistive positional touch sensing system.

Electronic Devices that Detect Applied Stress through Changes in Propagation of Vibrations

In some embodiments, applied stress as described above can be detected, located or measured (or two or more of these) by detecting changes in the propagation of vibrations (which as used herein includes standing or resonant vibrations) within or along the surface of an electronic device. One or more transducers are used to initiate one or more vibration signals within or on the electronic device. One or more sensors are used to detect the vibration signals. The vibration signals that reach the sensors from the originating transducers depend on the mechanical design and materials of the electronic device, as well as any stresses that are applied to the surface of the electronic device. The generation and detection of vibrations are well known in the art, and can be based on, for example, piezoelectric materials. The analysis of vibration signals is well known in the art, and can include analysis of amplitude, phase, pulse duration, dispersion, and spectral make-up. Vibration signal analysis can include fourier transformation and wavelet analysis, for example, as is known in the art. This disclosure is not intended to be limited by the specific modes of vibration signal analysis (i.e., as a result of applied stress) that are described herein. Others are known in the art and are useful for the present disclosure.

The vibration signal generating transducer or the sensors of the propagating vibration can be integrated with any one or more of the electronic device display, display cover layer, device housing, device buttons, device substructure (e.g., frame or strut elements not visible to the user). The member or members can be integrated with a device speaker. The vibration signal generating transducer or the sensors of the propagating vibration may comprise a transparent conductive material, for example a patterned transparent conductive material, for example a microscopic metal mesh, as described in U.S. Pat. Nos. 8,384,691 and 8,274,494 and PCT Patent Application Publication Nos. WO2012106417 and WO2011156447). The member or members may be advantageously placed at the periphery of a display or display cover layer.

The vibration signal generating transducer or the sensors of the propagating vibration may be supported by elastomeric materials components that are designed to vary in their contact area or contact force (or both) as a result of stress applied to the electronic devices.

The vibration signal generating transducer or the sensors of the propagating vibration may be mechanically coupled to damping materials.

The vibration signal generating transducer or the sensors of the propagating vibration may be integrated within or on the device in a portion of the device that is not the display region. The member or members may be coupled with a portion of the device that is intentionally designed to detect a balancing force to one or more forces applied to the display, and thusly detect, locate, or measure (or two or more of these) touches made to the display (e.g., by the finger or fingers of one or more users or by a stylus).

In FIG. 3, an electronic device 300 comprises display 305. A compressive force F is applied to display 305 at location 310. A vibration signal generating transducer 315 (also referred to herein as a transmitter) is located within the housing of device 300. A vibration sensing element (also referred to herein as a receiver or sensor) 320 is also located within the housing of device 300. The transducer 315 is connected to electronics (not shown) that drive the transducer to generate a vibration signal. The sensor 320 is connected to electronics (not shown) that interpret a vibration signal received by sensor 320. Depending on the level or magnitude of the force F, the received vibration signal is altered, thus providing a measurement of the level of magnitude of the force F.

The electronic device may comprise one or more electromechanical transmitters (i.e., transducers operating in a mode of converting input electrical signals into output mechanical vibration signal; e.g., piezoelectric or voice coil actuators) and one or more electromechanical receivers or sensors (e.g., piezoelectric, linear variable differential transformer). The transmitter sends a mechanical interrogation signal through the device or along the device surface. The one or more receivers or sensors receive mechanical vibration signals and convert the mechanical vibration signals to electrical signals, thus enabling analysis of the (received) mechanical vibration signals (e.g., phase, amplitude, pulse width, spectral shape). The received mechanical vibration signal or signals that reach the one or more receivers or sensors is affected by stress applied to the electronic device.

One or more of the aforementioned vibration sensors may be integrated within an electronic device in any such manner that stresses applied to the electronic devices results in changes in the detected vibration that originated at the vibration generating transducer. Electronic circuitry (e.g., oscillator circuits, filters, comparators, amplifiers, and microprocessors) can be combined with the vibration signal generating transducer or the sensors of the propagating vibration in order to determine changes in vibration propagation, as is known in the art. Determination of the stress or stresses applied to the surface of the electronic devices can be based on changes in the vibration propagation by logic operations carried out on the vibration changes, as well as reference to programmed or machine learned changes. Changes in vibration propagation to one or more (e.g., 2, 3, 4, 5, 6, 7, 8, 9, 10) sensors are thus associated with the existence, location, and magnitude of one or more stresses (normal and shear) applied to the surface of the electronic device.

Preferably, the vibration signal generating transducer and the sensors of the propagating vibration are placed in such a way that the accuracy and reliability of stress detection, location, and measurement are not impaired by the addition of a cover (e.g., backside cover) to the electronic device.

In some embodiments, changes in vibration propagation to two or more sensors are used in coordination (e.g., using a microprocessor and programmed or machine learned parameters) to detect, locate or measure (or two or more of these) stresses (e.g., localized stresses) applied to the surface of an electronic device (e.g., applied to the display of an electronic device).

One or more electromechanical transmitters (i.e., transducers operating in a mode of converting input electrical signals into output mechanical vibration; e.g., piezoelectric or voice coil actuators) and one or more electromechanical receivers (e.g., piezoelectric, linear variable differential transformer) can be used in the electronic devices disclosed herein. The transmitter or transmitters send a mechanical interrogation signal (vibration signal) through or along the surface of the the device. The one or more receivers (also described herein as sensors) convert mechanical (i.e., vibration) signal to an electrical signal, thus enabling analysis of the mechanical signal (e.g., phase, amplitude, pulse width, spectral shape). Mechanical signal or signals that reach the one or more receivers is affected by stress applied to the electronic device, thus allowing determination of the presence, location, and magnitude of one or more applied stresses.

In some embodiments, the determination of location or locations of one or more touches on the surface of an electronic device, for example on the display of the electronic device, is made using a first sensor or sensor element (e.g., a resistive or capacitive (for example projected capacitive) touch sensor) and the determination of the levels (also described herein as magnitudes) of force for the one or more touches is made using the one or more vibration signal generating transducers and the one or more sensors of the propagating vibration signal, as described herein. For more than one touch, the determination of the levels of force for the multiple touches (for example, to a display) can include determining the each level of touch force for each touch or a total force for all of the touches.

In some embodiments, a single transducer can be used first to generate a vibration signal that propagates within or along the surface of a device and then second to measure the same vibration signal after it has propagated within or along the surface of the device. Changes in the vibration signal can be correlated with stresses applied to the surface of the electronic devices.

In some embodiments, a vibration reflector may be integrated within or on the surface of the electronic device in order to tailor the propagation of the vibration signal.

Separation of Acceleration Forces from Distortion Forces

In some embodiments, acceleration (translational vs. rotational) forces are measured separately from distortion forces by: using accelerometer information to back-calculate acceleration forces; measuring the total stress distribution applied to the electronic devices; subtracting the acceleration forces from the total stress distribution in order to give a difference stress described herein as comprising distortion forces. Distortion forces include touch forces applied to the electronic display devices (when balanced by an opposing force, thus restricting overall motion of the device), as well as squeezing forces. The term acceleration force refers to a force (or the net force derived from a combination of forces) which imparts changes in translational or rotational velocity to the electronic device.

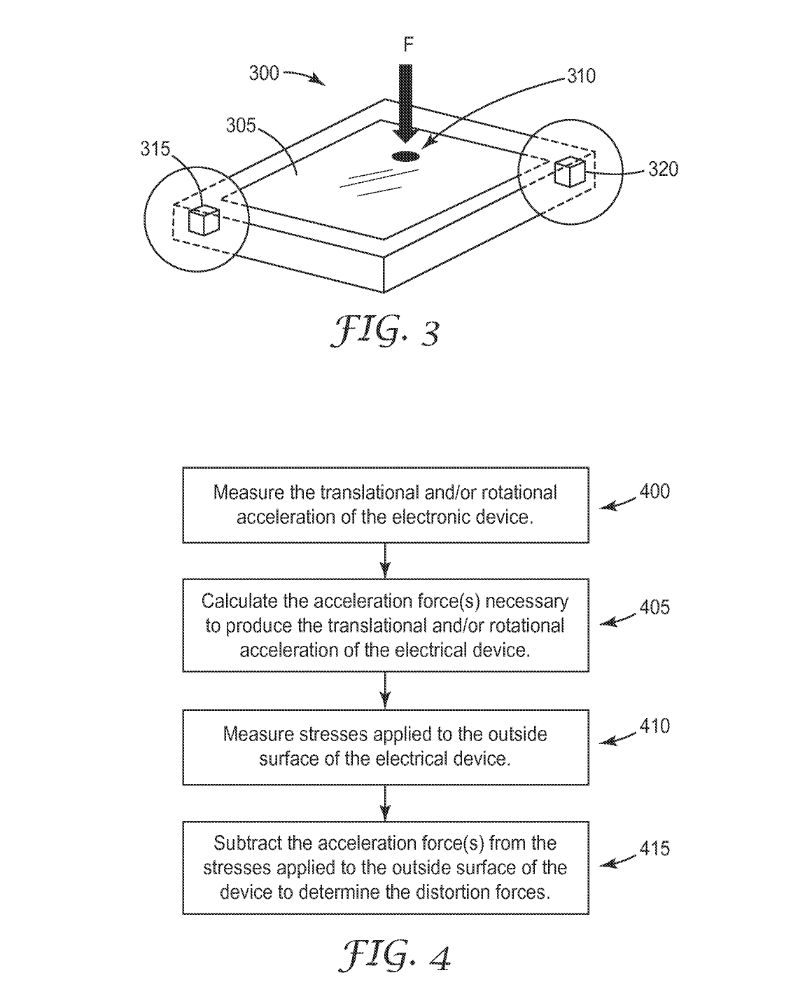

FIG. 4 is a flow chart showing a sequence of operations for improving the accuracy of measurement of forces applied to the surface of an electronic device, with the result being that forces applied for generating translational or rotational acceleration are separated from forces applied for distorting the device. The term forced applied for distorting the device refers to non-accelerating forces, and need not lead to any particular degree of distortion of the device. Firstly, in step 400, the acceleration of the device is determined, for example using accelerometers, as is known in the art. The acceleration can be translational or rotational (or both). Next, in step 405, a calculation of the force(s) necessary to produce the measured translational or rotational (or both) acceleration is made. Next, in step 410, a measurement of the stresses applied to outside of the electronic device is made. Finally, in step 415, the acceleration force(s) are subtracted from the stresses applied to the outside surface of the electronic device, leading to a determination of distortion forces.

In alternatives to the method captured in FIG. 4, the sequence of steps can be adjusted. Specifically, before step 415, any order of steps 400, 405, and 410 can be undertaken.

The following are items of the present disclosure:

Item 1 is a touch sensor comprising a resonant circuit having a resonant frequency configured to change in response to a force applied to the touch sensor, the touch sensor detecting the applied force by detecting a change in the resonant frequency.

Item 2 is the touch sensor of item 1, wherein the resonant circuit comprises a capacitor having a capacitance, the capacitance changing in response to a force applied to the touch sensor, the change in the capacitance changing the resonant frequency.

Item 3 is the touch sensor of item 2, wherein the capacitor comprises parallel first and second conductive electrodes forming the capacitor, the first conductive electrode being substantially transparent.

Item 4 is the touch sensor of item 3 having a touch sensitive area, the first conductive electrode extending across and covering the touch sensitive area.

Item 5 is the touch sensor of item 2 further comprising a resistor and an inductor.

Item 6 is the touch sensor of item 1, wherein the resonant circuit comprises a resistor having a resistance, the resistance changing in response to a force applied to the touch sensor, the change in the resistance changing the resonant frequency.

Item 7 is the touch sensor of item 6 further comprising a capacitor and an inductor.

Item 8 is the touch sensor of item 1, wherein the resonant circuit comprises a piezoelectric material having the resonant frequency.

1. A touch sensor comprising a resonant circuit having a resonant frequency configured to change in response to a force applied to the touch sensor, the touch sensor detecting the applied force by detecting a change in the resonant frequency.

2. The touch sensor of claim 1, wherein the resonant circuit comprises a capacitor having a capacitance, the capacitance changing in response to a force applied to the touch sensor, the change in the capacitance changing the resonant frequency.

3. The touch sensor of claim 2, wherein the capacitor comprises parallel first and second conductive electrodes forming the capacitor, the first conductive electrode being substantially transparent.

4. The touch sensor of claim 3 having a touch sensitive area, the first conductive electrode extending across and covering the touch sensitive area.

5. The touch sensor of claim 2 further comprising a resistor and an inductor.

6. The touch sensor of claim 1, wherein the resonant circuit comprises a resistor having a resistance, the resistance changing in response to a force applied to the touch sensor, the change in the resistance changing the resonant frequency.

7. The touch sensor of claim 6 further comprising a capacitor and an inductor.

8. The touch sensor of claim 1, wherein the resonant circuit comprises a piezoelectric material having the resonant frequency.
